(19) United States
(12) Patent Application Publication
(10) Pub. No.: US 2020/0153294 A1
(43) Pub. Date: May 14, 2020

(54) ROTOR AND MOTOR

(71) Applicant: Nidec Corporation, Kyoto (JP)

(72) Inventors: Masato AONO, Kyoto (JP); Takayuki MIGITA, Kyoto (JP); Akihiro OKITA, Kyoto (JP)

(21) Appl. No.: 16/615,853

(22) PCT Filed: Jun. 1, 2018
(86) PCT No.: PCT/JP2018/021169

§ 371 Date: Nov. 22, 2019

(30) Foreign Application Priority Data
Jun. 29, 2017 (JP) 2017-127508

(51) Int. Cl. H02K 1/27; H02K 7/00; H02K 5/00; H02K 21/14

(52) U.S. Cl. CPC H02K 1/2706; H02K 21/14; H02K 5/00; H02K 7/003

(57) ABSTRACT

A rotor includes a shaft, a rotor core fixed to the shaft, a magnet radially outside of the rotor core, a rotor cover including a tubular portion surrounding the rotor core and the magnet, and a resin portion including at least a portion thereof radially inside of the rotor cover. The rotor core includes a core through hole passing through the rotor core in an axial direction. The rotor cover includes a flange portion projecting radially inward from the tubular portion. The flange portion is on a first side of the rotor core in the axial direction, and includes a cover through hole passing through the flange portion in the axial direction.

### CROSS REFERENCE TO RELATED APPLICATIONS

This is a U.S. national stage of PCT Application No. PCT/JP2018/021169, filed on Jun. 1, 2018, and priority under 35 U.S.C. § 119(a) and 35 U.S.C. § 365(b) is claimed from Japanese Application No. 2017-127508, filed Jun. 29, 2017, the entire disclosures of which are hereby incorporated herein by reference.

### 1. FIELD OF THE INVENTION

The present disclosure relates to a rotor and a motor.

### 2. BACKGROUND

A rotor including a rotor cover arranged to cover a rotor core and a permanent magnet, and a motor including such a rotor, are known.

In the rotor as mentioned above, it is necessary to restrain the rotor cover from rotating relative to the rotor core while preventing the permanent magnet from coming out of the rotor cover in an axial direction, for example.

An example method for preventing the permanent magnet from coming out of the rotor cover in the axial direction is a method of bending end portions of the rotor cover on both sides in the axial direction to define stoppers for the permanent magnet. This method, however, may permit a gap to be defined between the permanent magnet and the bent portion of the rotor cover, allowing the permanent magnet to move in the axial direction inside of the rotor cover, when an error has occurred in axial dimension of the permanent magnet. Therefore, it may be difficult to stably hold the permanent magnet inside of the rotor cover.

Meanwhile, an example method for restraining the rotor cover from rotating relative to the rotor core is a method of adhering the rotor cover to the permanent magnet through an adhesive with the permanent magnet being fixed to the rotor core. This method, however, may fail to restrain the rotor cover from rotating relative to the rotor core if the adhesive comes off.

### SUMMARY

A rotor according to an example embodiment of the present disclosure includes a shaft extending along a central axis extending in an axial direction, a rotor core fixed to the shaft, at least one magnet radially outside of the rotor core, a rotor cover including a tubular portion surrounding the rotor core and the at least one magnet on a radially outer side of the at least one magnet, and a resin portion including at least a portion thereof radially inside of the rotor cover. The rotor core includes a core through hole passing through the rotor core in the axial direction. The rotor cover includes a flange portion projecting radially inward from the tubular portion. The flange portion is on a first side of the rotor core in the axial direction, and includes a cover through hole passing through the flange portion in the axial direction. The resin portion includes a first cover portion on the first side of the rotor core, the at least one magnet, and the flange portion in the axial direction, a second cover portion on a second side of the rotor core and the at least one magnet in the axial direction, a first joining portion extending in the axial direction through the core through hole to join the first cover portion and the second cover portion to each other, and a second joining portion extending in the axial direction through the cover through hole to join the first cover portion and the second cover portion to each other.

A motor according to an example embodiment of the present disclosure includes the above-described rotor, and a stator radially opposite to the rotor with a gap therebetween.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a sectional view of a motor according to a first example embodiment of the present disclosure.

FIG. 2 is a perspective view of portions of a rotor according to the first example embodiment.

FIG. 3 is a perspective view of portions of the rotor according to the first example embodiment.

FIG. 4 is an exploded perspective view of portions of the rotor according to the first example embodiment.

FIG. 5 is a sectional view of the rotor according to the first example embodiment taken along line V-V in FIG. 3.

FIG. 6 is a sectional view of the rotor according to the first example embodiment taken along line VI-VI in FIG. 3.

FIG. 7 is a diagram illustrating portions of the rotor according to the first example embodiment when viewed from a lower side.

FIG. 8 is a perspective view of portions of the rotor according to the first example embodiment.

FIG. 9 is a perspective view of portions of a rotor according to a first modification of the first example embodiment.

FIG. 10 is a diagram illustrating portions of a rotor according to a second modification of the first example embodiment when viewed from the lower side.

FIG. 11 is a perspective view of portions of a rotor according to a second example embodiment of the present disclosure.

FIG. 12 is a perspective view of a portion of a rotor cover according to the second example embodiment.

FIG. 13 is a sectional view of the rotor according to the second example embodiment taken along line XIII-XIII in FIG. 11.

### DETAILED DESCRIPTION

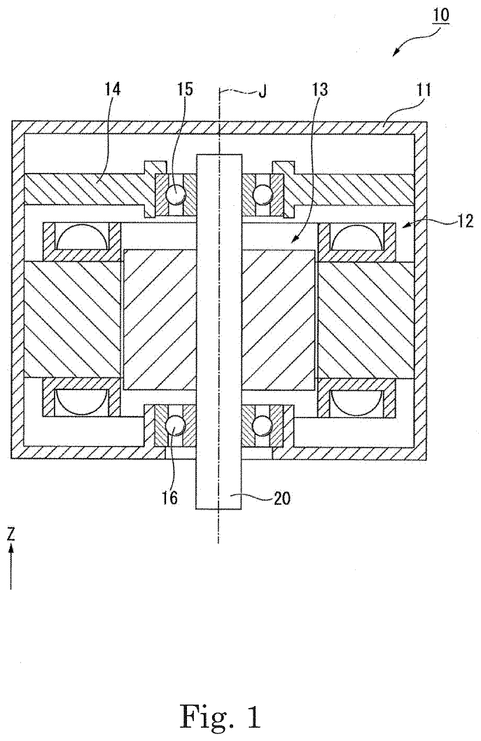

Referring to FIG. 1, a motor 10 according to a first example embodiment of the present disclosure includes a housing 11, a stator 12, a rotor 13 including a shaft 20 arranged to extend along a central axis J extending in one direction, a bearing holder 14, and bearings 15 and 16. The stator 12 is arranged opposite to the rotor 13 with a radial gap therebetween on a radially outer side of the rotor 13. The shaft 20 is rotatably supported by the bearings 15 and 16. The shaft 20 is columnar, and is arranged to extend in an axial direction Z.

In the accompanying drawings, a direction parallel to the one direction in which the central axis J extends is represented as a z-axis. In the following description, the direction parallel to the one direction in which the central axis J extends is simply referred to as the “axial direction Z”. Radial directions centered on the central axis J are each simply referred to by the term “radial direction”, “radial”, or “radially”, and a circumferential direction about the central axis J is simply referred to by the term “circumferential direction”, “circumferential”, or “circumferentially”. In addition, a positive side in a z-axis direction is referred to as an upper side, while a negative side in the z-axis direction is referred to as a lower side.

In the present example embodiment, the lower side corresponds to a first side in the axial direction. The upper side corresponds to a second side in the axial direction. Note that the upper side and the lower side are defined simply to describe relative positions of different members or portions, and that an actual positional relationship or the like may be a positional relationship or the like different from a positional relationship or the like which will be described using the above definitions of the upper side and the lower side.

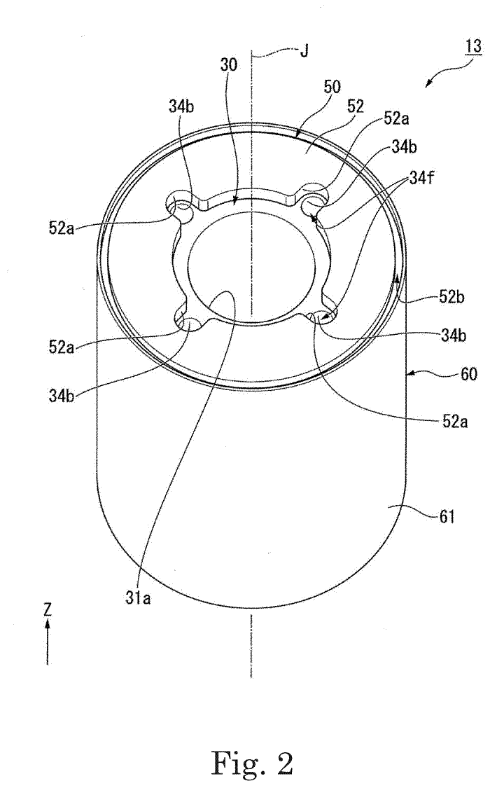

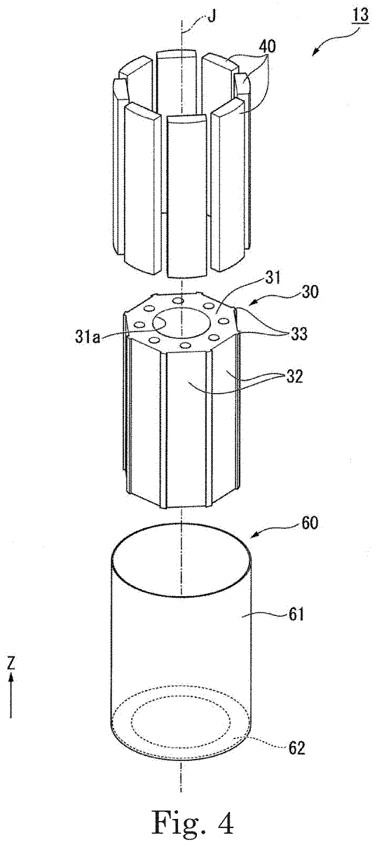

Referring to FIGS. 2 to 4, the rotor 13 according to the present example embodiment includes the shaft 20, a rotor core 30, a plurality of magnets 40, a rotor cover 60, and a resin portion 50. Referring to FIG. 4, the rotor core 30 is tubular, and is arranged to extend in the axial direction Z. Although not shown in the figures, the rotor core 30 is defined by, for example, a plurality of plate members placed one upon another in the axial direction Z. The rotor core 30 includes a rotor core body 31 and a plurality of projection portions 33.

The rotor core body 31 is arranged to extend in the axial direction Z. In more detail, the rotor core body 31 is in the shape of a regular octagonal prism with the central axis J as a center. The rotor core body 31 includes a plurality of magnet support surfaces 32. Each magnet support surface 32 is arranged to extend in the axial direction Z. The magnet support surface 32 is a flat surface perpendicular to a radial direction. Each of the magnet support surfaces 32 corresponds to a separate one of a plurality of radially outer surfaces of the rotor core body 31 in the shape of a regular octagonal prism.

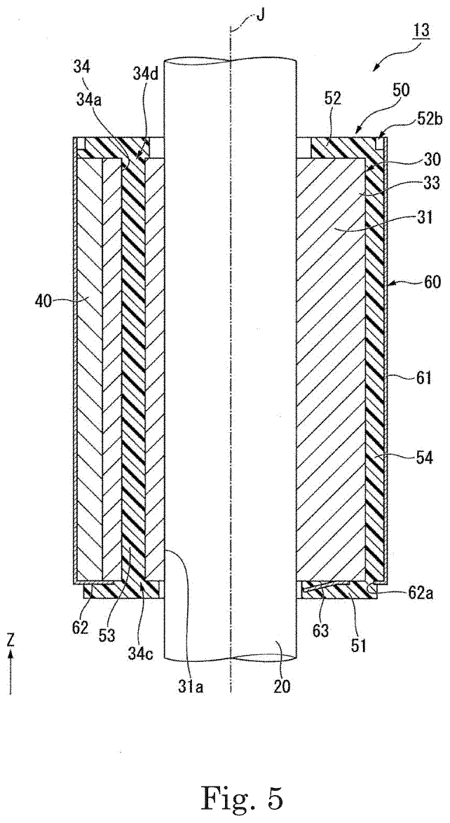

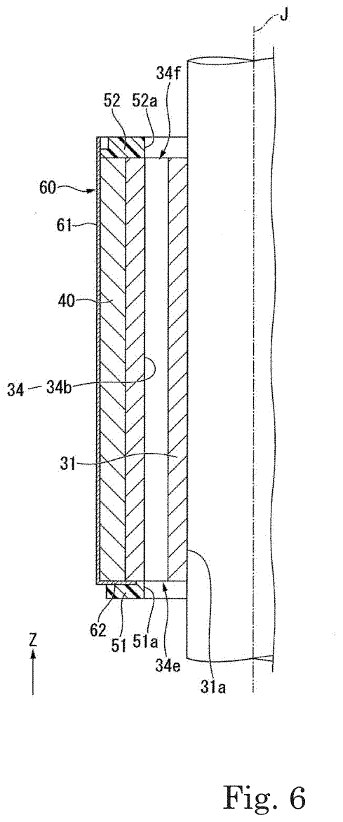

The rotor core body 31 includes a fixing hole portion 31a arranged to pass through the rotor core body 31 in the axial direction Z. The fixing hole portion 31a is circular and is centered on the central axis J when viewed along the axial direction Z. Referring to FIGS. 5 and 6, the shaft 20 is passed through the fixing hole portion 31a. A wall surface of the fixing hole portion 31a is fixed to an outer circumferential surface of the shaft 20. The rotor core 30 is thus fixed to the shaft 20.

Referring to FIG. 4, each projection portion 33 is arranged to project radially outward from the rotor core body 31. The projection portion 33 is arranged to extend from an upper end portion of the rotor core body 31 to a lower end portion of the rotor core body 31. A radially outer surface of the projection portion 33 is a flat surface perpendicular to a radial direction.

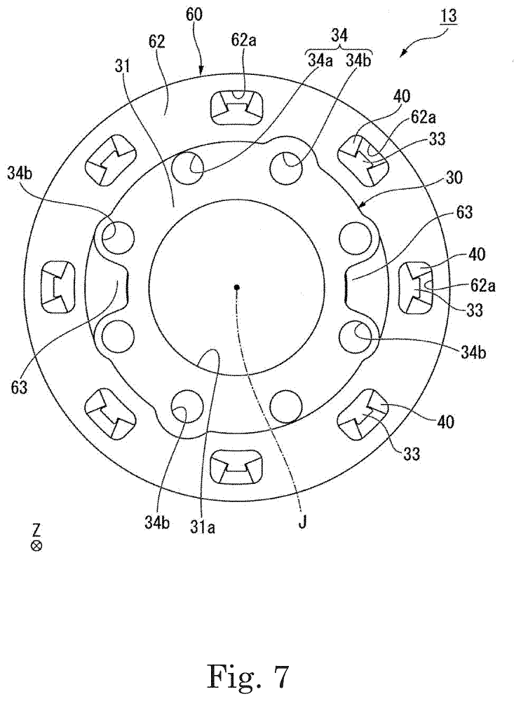

Referring to FIG. 7, the circumferential dimension of the projection portion 33 is arranged to gradually increase in a radially outward direction from a radially inner side. The projection portions 33 are arranged in a circumferential direction all the way around the central axis J. The projection portions 33 are, for example, equally spaced from one another in the circumferential direction. The number of projection portions 33 is, for example, eight. Each of the eight projection portions 33 is arranged to project radially outward from a separate one of angle portions of the rotor core body 31 in the shape of a regular octagonal prism.

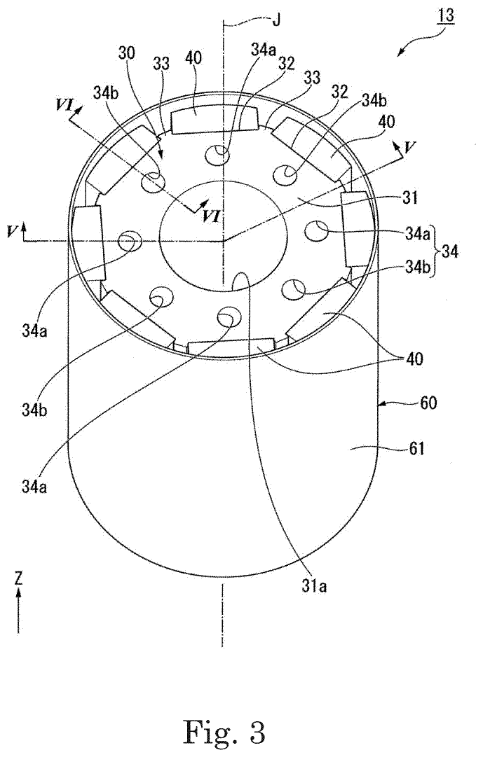

The rotor core 30 includes a plurality of core through holes 34 each of which is arranged to pass through the rotor core 30 in the axial direction Z. Each core through hole 34 is arranged to pass through the rotor core body 31 in the axial direction Z. The core through holes 34 are arranged in the circumferential direction all the way around the central axis J. The core through holes 34 are, for example, equally spaced from one another in the circumferential direction. Each core through hole 34 is circular when viewed along the axial direction Z. The number of core through holes 34 is, for example, eight. Referring to FIG. 3, each of the core through holes 34 is arranged radially inside of a separate one of the magnets 40.

At least one of the core through holes 34 is a first core through hole 34a arranged to have one of first joining portions 53, which will be described below, passing therethrough. Referring to FIG. 5, opening portions 34c and 34d of the first core through hole 34a on both sides in the axial direction are closed by the resin portion 50.

Referring to FIG. 3, at least one of the other core through holes 34 is a second core through hole 34b arranged at a position different from that of each first joining portion 53 when viewed along the axial direction Z. The wording “the second core through hole is arranged at a position different from that of the first joining portion when viewed along the axial direction” as used herein is intended to include at least a portion of the second core through hole not overlapping with the first joining portion when viewed along the axial direction.

Referring to FIGS. 2 and 6, at least one of opening portions 34e and 34f of each second core through hole 34b on both sides in the axial direction is exposed to an outside of the rotor 13. Therefore, even after the resin portion 50 has been molded to manufacture the rotor 13, a jig can be inserted into the second core through hole 34b through one of the opening portions 34e and 34f which is exposed, for example, to position the rotor 13 in the circumferential direction.

In the present example embodiment, both of the opening portions 34e and 34f of each second core through hole 34b on both sides in the axial direction are exposed to the outside of the rotor 13. The opening portion 34e of the second core through hole 34b on the lower side is exposed to the lower side of the rotor 13. The opening portion 34f of the second core through hole 34b on the upper side is exposed to the upper side of the rotor 13. Referring to FIG. 6, the resin portion 50 is not arranged in an interior of the second core through hole 34b. The interior of the second core through hole 34b is a space joined to a space outside of the rotor 13 through each of the opening portions 34e and 34f.

Referring to FIG. 7, in the present example embodiment, two or more of the core through holes 34 are the first core through holes 34a, while the other core through holes 34 are the second core through holes 34b. The first core through holes 34a and the second core through holes 34b are arranged to alternate with each other in the circumferential direction. The number of first core through holes 34a and the number of second core through holes 34b are, for example, both four.

Referring to FIG. 4, each magnet 40 is substantially in the shape of a quadrangular prism, having flat horizontal surfaces and extending in the axial direction Z. Referring to FIG. 5, each magnet 40 is arranged radially outside of the rotor core 30. Referring to FIGS. 3 and 4, the magnets 40 are arranged apart from one another in the circumferential direction. In more detail, the magnets 40 are arranged at regular intervals in the circumferential direction all the way around the central axis J. The circumferential distance between circumferentially adjacent ones of the magnets 40 is arranged to gradually increase in the radially outward direction from the radially inner side.

Referring to FIG. 3, each of the magnets 40 is arranged between circumferentially adjacent ones of the projection portions 33. End portions of each magnet 40 on both circumferential sides are arranged to be in contact with the projection portions 33 that are adjacent to the magnet 40 on both circumferential sides of the magnet 40. In more detail, a radially inner end portion of each of the end portions of the magnet 40 on both circumferential sides is arranged to be in contact with the corresponding projection portion 33. Thus, circumferential positioning of the magnets 40 can be achieved through the projection portions 33. Note that at least one of the end portions of the magnet 40 on both circumferential sides may not be in contact with the corresponding projection portion 33.

Each of the magnets 40 is supported by a separate one of the magnet support surfaces 32 from the radially inner side. A radially inner surface of the magnet 40 is a flat surface perpendicular to a radial direction, and is arranged to be in contact with the corresponding magnet support surface 32. A radially outer surface of the magnet 40 is a curved surface that is curved in the circumferential direction along a radially inner surface of a tubular portion 61, which will be described below, of the rotor cover 60. A center of curvature of the radially outer surface of each magnet 40 coincides with the central axis J. When the radially outer surface of the magnet 40 is such a curved surface, an improvement in magnetic characteristics of the motor 10 can be achieved. The radially outer surface of the magnet 40 is arranged to be in contact with a radially inner surface of the rotor cover 60. Thus, the magnet 40 is radially held between the rotor core 30 and the rotor cover 60 while being in contact with the rotor core 30 and the rotor cover 60.

Referring to FIG. 5, the dimension of the magnet 40 measured in the axial direction Z is, for example, equal to the dimension of the rotor core 30 measured in the axial direction Z. An upper surface of the magnet 40 and an upper surface of the rotor core 30 are, for example, arranged on the same plane perpendicular to the axial direction Z. A lower surface of the magnet 40 and a lower surface of the rotor core 30 are, for example, arranged on the same plane perpendicular to the axial direction Z.

Referring to FIGS. 4 and 5, the rotor cover 60 includes the tubular portion 61, a flange portion 62, and first claw portions 63. The tubular portion 61 is tubular, and is arranged to extend in the axial direction Z. In more detail, the tubular portion 61 is cylindrical, and is centered on the central axis J. The tubular portion 61 is arranged to open to both sides in the axial direction Z. Referring to FIG. 5, the tubular portion 61 is arranged to surround the rotor core 30 and the magnets 40 on the radially outer side of the magnets 40. An upper end portion of the tubular portion 61 is arranged at a level higher than that of an upper end portion of each magnet 40 and that of an upper end portion of the rotor core 30.

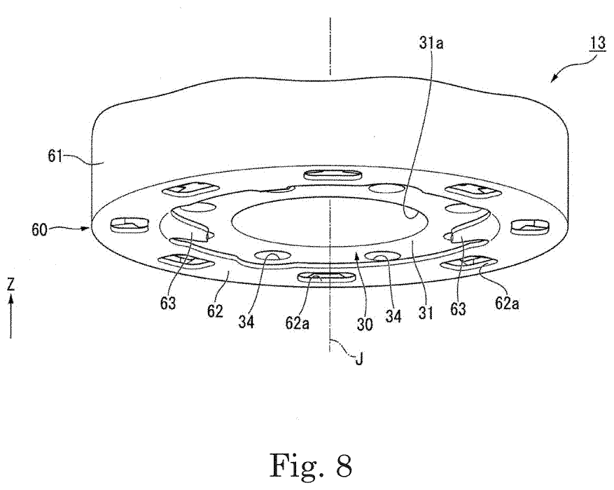

The flange portion 62 is arranged to project radially inward from the tubular portion 61. In more detail, the flange portion 62 is arranged to project radially inward from a lower end portion of the tubular portion 61. Referring to FIGS. 7 and 8, the flange portion 62 is in the shape of an annular plate, and is arranged to extend in the circumferential direction. Referring to FIG. 5, the flange portion 62 is arranged on the lower side of the rotor core 30 and the magnets 40. A radially outer edge portion of a lower surface of the rotor core body 31 and the lower surface of each magnet 40 are arranged to be in contact with an upper surface of the flange portion 62. The rotor core 30 and the magnets 40 are thus supported by the flange portion 62 from the lower side. Referring to FIG. 7, a radially inner edge of the flange portion 62 is arranged radially outward of the core through holes 34.

The flange portion 62 includes a plurality of cover through holes 62a each of which is arranged to pass through the flange portion 62 in the axial direction Z. The cover through holes 62a are arranged in the circumferential direction all the way around the central axis J. The cover through holes 62a, which are adjacent to one another in the circumferential direction, are, for example, equally spaced from one another. Each cover through hole 62a is in the shape of a rectangle with substantially rounded corners and having longer sides extending in the circumferential direction when viewed along the axial direction Z.

Each cover through hole 62a is arranged to overlap with a space between circumferentially adjacent ones of the magnets 40 when viewed along the axial direction Z. Each cover through hole 62a is arranged to overlap with the corresponding projection portion 33 when viewed along the axial direction Z. In the present example embodiment, each cover through hole 62a is arranged at the same circumferential position as that of the corresponding projection portion 33. Each cover through hole 62a is arranged radially outside of a space between circumferentially adjacent ones of the core through holes 34.

Referring to FIGS. 5 and 8, each first claw portion 63 is in the shape of a plate, and is arranged to extend radially inward from the radially inner edge of the flange portion 62 while extending obliquely downward. That is, the first claw portion 63 is arranged to extend from the flange portion 62 in a direction at an angle to the axial direction Z. Thus, the first claw portion 63 projects to the lower side from the flange portion 62. That is, the first claw portion 63 is a claw portion arranged to project in the axial direction Z from the flange portion 62.

Referring to FIG. 7, a radially inner end portion of the first claw portion 63 is arranged radially outward of an edge of the fixing hole portion 31a. The first claw portion 63 is arranged between circumferentially adjacent ones of the core through holes 34, that is, circumferentially between one of the first core through holes 34a and one of the second core through holes 34b, when viewed along the axial direction Z. The circumferential dimension of the first claw portion 63 is arranged to gradually decrease in a radially inward direction from the radially outer side. Referring to FIGS. 7 and 8, the rotor cover 60 according to the present example embodiment has two of the first claw portions 63. The two first claw portions 63 are arranged on mutually opposite sides of the central axis J, which lies therebetween in a radial direction.

Referring to FIGS. 2 and 5, at least a portion of the resin portion 50 is arranged radially inside of the rotor cover 60. The resin portion 50 is arranged to hold the rotor cover 60, the rotor core 30, and the magnets 40 while joining the rotor cover 60, the rotor core 30, and the magnets 40 to one another. In the present example embodiment, the resin portion 50 is molded as a single monolithic member by an insert molding process, i.e., by pouring a resin into a mold with the rotor core 30, the magnets 40, and the rotor cover 60 inserted therein. The resin portion 50 includes a first cover portion 51, a second cover portion 52, the first joining portions 53, and second joining portions 54.

Each of the first cover portion 51 and the second cover portion 52 is in the shape of an annular plate, and is centered on the central axis J. Referring to FIG. 5, the first cover portion 51 is arranged on the lower side of the rotor core 30, the magnets 40, and the flange portion 62. The first cover portion 51 is arranged to be in contact with a lower surface of the flange portion 62 and the lower surface of the rotor core 30. The first cover portion 51 is arranged below the tubular portion 61. The first cover portion 51 is arranged outside of the rotor cover 60.

A radially inner edge of the first cover portion 51 is arranged radially outward of the fixing hole portion 31a and radially inward of the first core through holes 34a. The first cover portion 51 is arranged to have an outside diameter smaller than the outside diameter of the tubular portion 61. A radially outer edge of the first cover portion 51 is arranged radially outward of the cover through holes 62a and radially inward of an outer circumferential surface of the tubular portion 61. The first cover portion 51 is arranged to close the first core through holes 34a and the cover through holes 62a from the lower side.

The first claw portions 63 are buried in the first cover portion 51. Thus, the first claw portions 63, which are claw portions, are engaged with the resin portion 50. In the present example embodiment, each first claw portion 63 is entirely buried in the first cover portion 51.

The second cover portion 52 is arranged on the upper side of the rotor core 30 and the magnets 40. The second cover portion 52 is arranged radially inside of the upper end portion of the tubular portion 61. The second cover portion 52 is arranged to be in contact with the upper surface of each magnet 40 and the upper surface of the rotor core 30. An upper surface of the second cover portion 52 is arranged, for example, at the same level as that of the upper end portion of the tubular portion 61 in the axial direction Z.

A radially inner edge of the second cover portion 52 is arranged radially outward of the fixing hole portion 31a and radially inward of the first core through holes 34a. The second cover portion 52 is arranged to have an outside diameter substantially equal to the inside diameter of the tubular portion 61. A radially outer edge of the second cover portion 52 is arranged to be in contact with an inner circumferential surface of the tubular portion 61. The second cover portion 52 is arranged to close the first core through holes 34a from the upper side.

The second cover portion 52 has a shoulder portion 52b at a radially outer edge portion thereof. The shoulder portion 52b is defined by a portion of the upper surface of the second cover portion 52 being recessed to the lower side at a radially outer edge thereof. Referring to FIG. 2, the shoulder portion 52b is defined all the way around the radially outer edge portion of the second cover portion 52.

Referring to FIG. 6, the first cover portion 51 and the second cover portion 52 include recessed portions 51a and 52a, respectively. Referring to FIG. 2, the second cover portion 52 has four of the recessed portions 52a. Each recessed portion 52a is recessed radially outward from the radially inner edge of the second cover portion 52. The four recessed portions 52a are arranged at regular intervals in the circumferential direction all the way around the central axis J. Each recessed portion 52a is arranged to overlap with one of the second core through holes 34b when viewed along the axial direction Z. That is, the opening portion 34f of each second core through hole 34b on the upper side is exposed to the upper side of the rotor 13 through one of the recessed portions 52a.

Although not shown in the figures, the first cover portion 51 has four of the recessed portions 51a as the second cover portion 52 has four of the recessed portions 52a. Referring to FIG. 6, each recessed portion 51a is recessed radially outward from the radially inner edge of the first cover portion 51. The opening portion 34e of each second core through hole 34b on the lower side is exposed to the lower side of the rotor 13 through one of the recessed portions 51a.

Referring to FIG. 5, each first joining portion 53 is arranged to extend in the axial direction Z through one of the core through holes 34 to join the first cover portion 51 and the second cover portion 52 to each other. This contributes to preventing the resin portion 50 from coming off the rotor core 30, and joining the resin portion 50 and the rotor core 30 to each other. Each first joining portion 53 is arranged to pass through one of the first core through holes 34a of the core through holes 34. The first joining portion 53 is columnar, and is arranged to extend in the axial direction Z. An outer circumferential surface of the first joining portion 53 is arranged to be in contact with a wall surface of the corresponding first core through hole 34a. The first joining portion 53 is arranged to fill the corresponding first core through hole 34a.

In the present example embodiment, the resin portion 50 includes two or more of the first joining portions 53. Each of the first joining portions 53 is arranged to pass through a separate one of the first core through holes 34a. The resin portion 50 and the rotor core 30 can thus be more firmly joined to each other.

Each second joining portion 54 is arranged to extend in the axial direction Z through one of the cover through holes 62a to join the first cover portion 51 and the second cover portion 52 to each other. This contributes to preventing the resin portion from coming off the rotor cover 60, and joining the resin portion 50 and the rotor cover 60 to each other.

As described above, according to the present example embodiment, the first cover portion 51 and the second cover portion 52 are joined to each other through the first joining portions 53 passing through the first core through holes 34a and the second joining portions 54 passing through the cover through holes 62a, whereby the rotor core 30 and the rotor cover 60 are joined to each other through the resin portion 50. This contributes to preventing the rotor core 30 from coming out of the rotor cover 60 in the axial direction Z, and restraining the rotor cover 60 from rotating relative to the rotor core 30. In addition, unlike in the case where an adhesive is used, a reduction in the likelihood that the fixing of the rotor core 30 to the rotor cover 60 will be released when, for example, various portions have experienced thermal expansion can be achieved. This contributes to appropriately restraining the rotor cover 60 from rotating relative to the rotor core 30.

In addition, each of the first cover portion 51 and the second cover portion 52 is able to serve as a stopper to prevent each magnet 40 from coming off in the axial direction Z. Thus, a reduction in the likelihood that each magnet 40 will come out of the rotor cover 60 in the axial direction Z can be achieved. In addition, because the rotor cover 60 includes the flange portion 62 arranged on the lower side of the rotor core 30, the rotor core 30 and the magnets 40 can be supported by the flange portion 62 from the lower side. This contributes to more effectively preventing the rotor core 30 and the magnets 40 from coming out of the rotor cover 60 to the lower side.

In addition, according to the present example embodiment, the resin portion 50 can be made by the above-described insert molding process. Thus, the resin portion 50 being in contact with the magnets 40 can be easily made even when a dimensional error of any magnet 40 has occurred. This contributes to preventing a gap from being defined between the resin portion 50 and each magnet 40, and holding the magnets 40 stably in the rotor cover 60.

Thus, the rotor 13 according to the present example embodiment is able to restrain the rotor cover 60 from rotating relative to the rotor core 30 while allowing the magnets 40 to be stably held inside of the rotor cover 60. Because portions of the rotor 13 can be restrained from moving relative to each other, a reduction in vibrations generated from the motor 10 can be achieved. Accordingly, a reduction in noise generated from the motor 10 can be achieved, while the motor 10 is allowed to operate efficiently.

In addition, because the resin portion 50 has both the function of holding the magnets 40 and the function of preventing the rotation of the rotor cover 60, a reduction in the number of steps for assembling the rotor 13 can be easily achieved. Specifically, both stable holding of the magnets 40 and appropriate prevention of the rotation of the rotor cover 60 can be accomplished by making the resin portion 50 by the above-described insert molding process. Accordingly, the assembly of the rotor 13 can be made easier than in the case where, for example, both end portions of a cover in the axial direction are bent to define stoppers for magnets and the cover is adhered to the magnets through an adhesive. In addition, since use of an adhesive to hold the magnets 40 is not necessary, a step and equipment for hardening an adhesive are not necessary.

In addition, in the present example embodiment, the rotor cover 60 includes the first claw portions 63 as claw portions that are engaged with the resin portion 50. Thus, the rotor cover 60 is more effectively restrained from rotating relative to the resin portion 50 with the first claw portions 63 being engaged with the resin portion 50. This contributes to more effectively restraining the rotor cover 60 from rotating relative to the rotor core 30. The first claw portions 63 are buried in the first cover portion 51, and are therefore firmly fixed to the resin portion 50. Accordingly, the rotor cover 60 and the resin portion 50 can be joined to each other more firmly, which contributes to more effectively restraining the rotor cover 60 from rotating relative to the rotor core 30.

In addition, in the present example embodiment, each first claw portion 63 is arranged to extend from the flange portion 62 in a direction at an angle to the axial direction Z. This contributes to increasing the dimension of the first claw portion 63 measured in the direction in which the first claw portion 63 extends while making the dimension of the first claw portion 63 measured in the axial direction Z relatively small. Thus, the length of a portion of the first claw portion 63 which is buried in the first cover portion 51 can be increased to allow the first claw portion 63 to be more firmly fixed to the resin portion 50. This contributes to more effectively restraining the rotor cover 60 from rotating relative to the rotor core 30.

Each second joining portion 54 is arranged to pass through the space between circumferentially adjacent ones of the magnets 40. Thus, the circumferentially adjacent ones of the magnets 40 can be joined to each other through the second joining portion 54. This contributes to preventing each magnet 40 from being displaced in the circumferential direction.

In the present example embodiment, each cover through hole 62a is arranged to overlap with the space between circumferentially adjacent ones of the magnets 40 when viewed along the axial direction Z. This arrangement makes it easier to pass the resin through the cover through hole 62a and the space between the circumferentially adjacent ones of the magnets 40 when the resin portion 50 is made by the above-described insert molding process. Thus, the space between the circumferentially adjacent ones of the magnets 40 can be properly filled with the resin to make the second joining portion 54. This contributes to more effectively preventing each magnet 40 from being displaced in the circumferential direction. In addition, it is easy to check the circumferential positions of the magnets 40 through the cover through hole 62a before the resin portion 50 is made.

In the present example embodiment, the resin portion 50 includes two or more of the second joining portions 54. Each of the second joining portions 54 is arranged to pass through a separate one of the cover through holes 62a. The resin portion 50 and the rotor cover 60 can thus be more firmly joined to each other. This contributes to more effectively restraining the rotor cover 60 from rotating relative to the rotor core 30. In the present example embodiment, since the cover through holes 62a are arranged in the circumferential direction all the way around the central axis J, the second joining portions 54, which are arranged to pass through the cover through holes 62a, are also arranged in the circumferential direction all the way around the central axis J. Thus, the rotor cover 60 can be joined to the resin portion 50 stably all the way around the central axis J. This contributes to more effectively restraining the rotor cover 60 from rotating relative to the rotor core 30. The second joining portions 54, which are adjacent to one another in the circumferential direction, are, for example, equally spaced from one another.

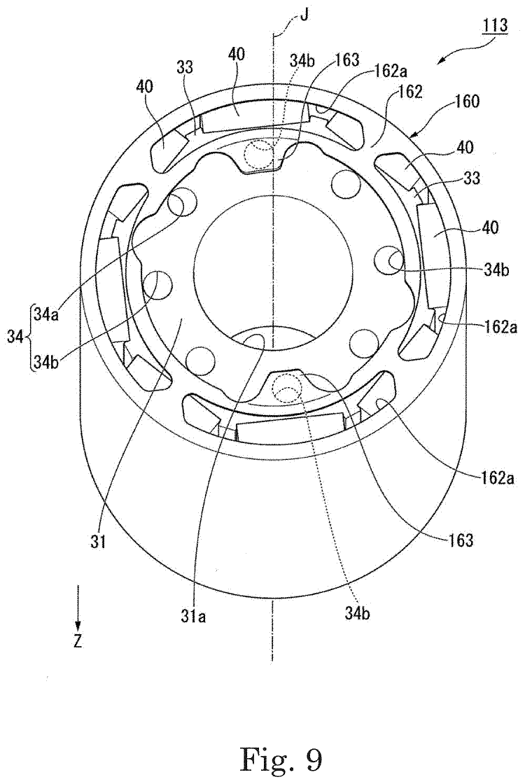

Referring to FIG. 9, in a rotor 113 according to a first modification of the first example embodiment, each of cover through holes 162a of a rotor cover 160 is arranged to extend in the circumferential direction. The cover through hole 162a is arranged to have a circumferential dimension equal to or greater than the circumferential dimension of each of magnets 40. Thus, even in the case where accuracy in circumferential positioning of the rotor cover 160 is relatively low, it is easy to arrange each of the cover through holes 162a to overlap with a space between adjacent ones of the magnets 40 when viewed along the axial direction Z. Thus, it can be made easier to pour a resin into the space between the adjacent ones of the magnets 40 when a resin portion 50 is made by the above-described insert molding process.

In the present modification, the circumferential dimension of each cover through hole 162a is, for example, about twice the circumferential dimension of each magnet 40. In the present modification, a flange portion 162 has four of the cover through holes 162a. In FIG. 9, two projection portions 33 and three of the magnets 40 are arranged to overlap with each of the cover through holes 162a when viewed along the axial direction Z. In the present modification, each of first claw portions 163 is, for example, arranged to overlap with one of second core through holes 34b when viewed along the axial direction Z.

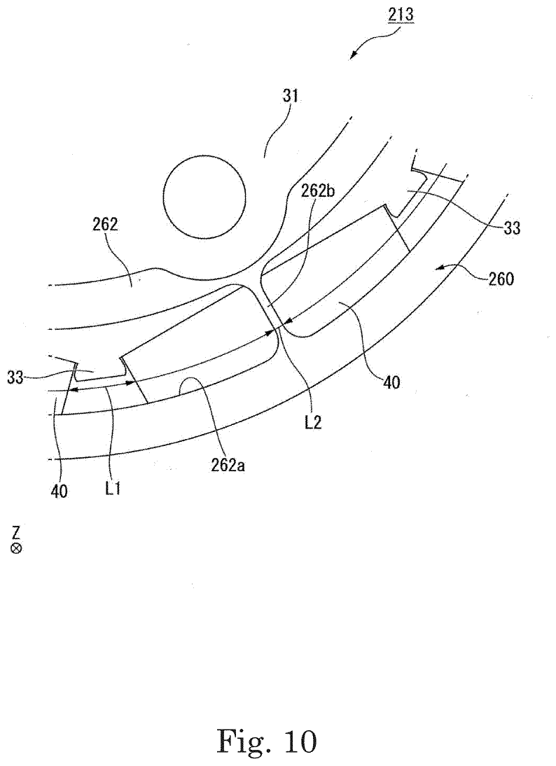

Referring to FIG. 10, in a rotor 213 according to a second modification of the first example embodiment, each of cover through holes 262a of a rotor cover 260 is arranged to extend in the circumferential direction. Each cover through hole 262a is arranged to have a circumferential dimension greater than the circumferential dimension of each cover through hole 162a illustrated in FIG. 9. A circumferential dimension L2 of a portion 262b of a flange portion 262 which lies between circumferentially adjacent ones of the cover through holes 262a is smaller than a circumferential distance L1 between circumferentially adjacent ones of magnets 40. Therefore, even in the case where the portion 262b overlaps with a space between the circumferentially adjacent ones of the magnets 40 when viewed along the axial direction Z, for example, a portion of the space between the magnets 40 overlaps with at least one of the cover through holes 262a. Thus, it can be made easier to pour a resin into the space between the adjacent ones of the magnets 40 when a resin portion 50 is made by the above-described insert molding process.

Each of the distance L1 and the dimension L2 varies at different radial positions. It may be sufficient if the dimension L2 is smaller than the distance L1 at the same radial position. That is, the dimension L2 at one radial position may be equal to or greater than the distance L1 at another radial position, for example. It is preferable that the circumferential dimension L2 of the portion 262b is, for example, equal to or greater than twice the thickness of the flange portion 262 measured in the axial direction Z. This will make it easier to punch and define the circumferentially adjacent ones of the cover through holes 262a by press working.

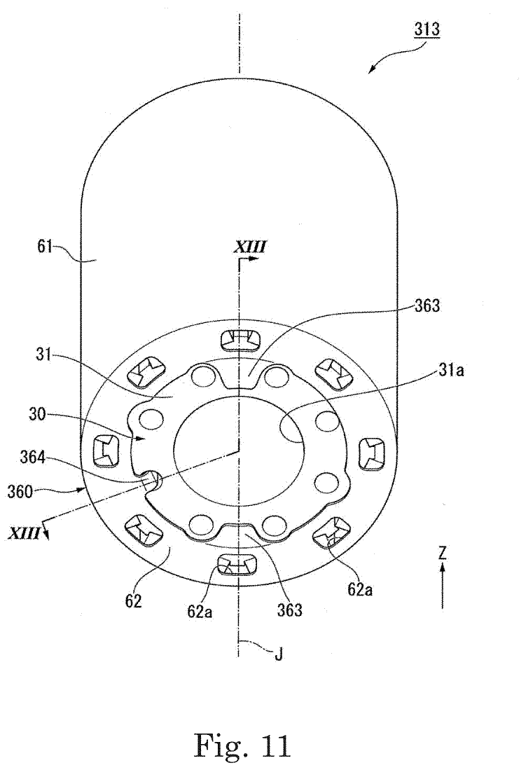

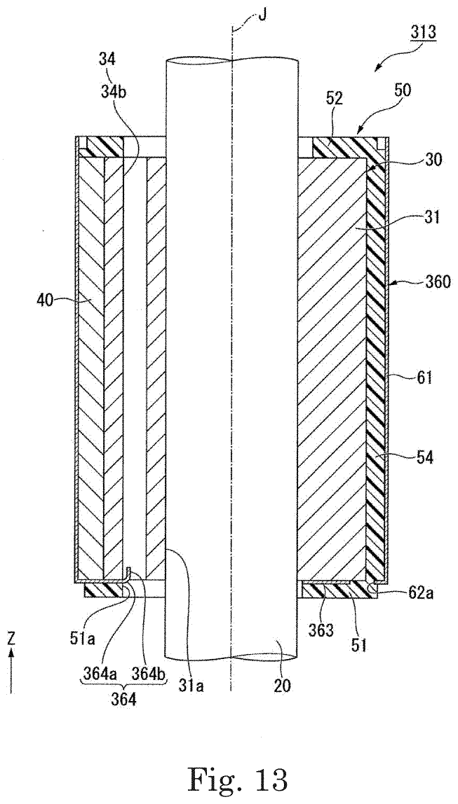

Referring to FIGS. 11 to 13, in a rotor 313 according to a second example embodiment of the present disclosure, a rotor cover 360 includes extension portions 363 and a second claw portion 364. Referring to FIGS. 11 and 13, each extension portion 363 is arranged to extend radially inward from a radially inner edge of a flange portion 62. The extension portions 363 are similar to the first claw portions 63 according to the first example embodiment except that the extension portions 363 extend in different directions. Each extension portion 363 is arranged to be in contact with a lower surface of a rotor core body 31 to support a rotor core 30 from the lower side.

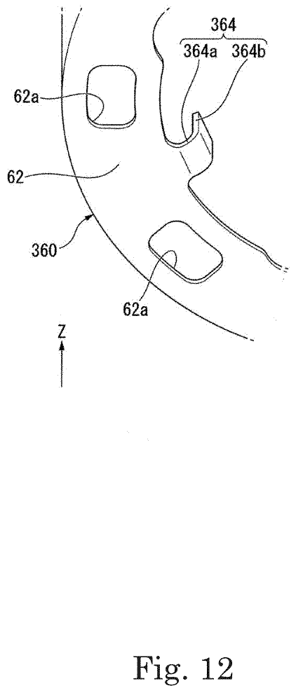

Referring to FIG. 12, the second claw portion 364 includes a plate-shaped first portion 364a arranged to project radially inward from the radially inner edge of the flange portion 62, and a plate-shaped second portion 364b arranged to extend to the upper side from a radially inner end portion of the first portion 364a. The second claw portion 364 is thus arranged to project to the upper side from the flange portion 62. That is, the second claw portion 364 is a claw portion arranged to project in the axial direction Z from the flange portion 62. The first portion 364a is arranged to curve upward as it extends radially inward from the radially outer side.

Referring to FIGS. 11 and 13, at least a portion of the second claw portion 364 is arranged in one of core through holes 34. As a result, the second claw portion 364, which serves as a claw portion, is engaged with the rotor core 30. Thus, the rotor cover 360 can be directly joined to the rotor core 30, which contributes to more effectively restraining the rotor cover 360 from rotating relative to the rotor core 30. In addition, circumferential positioning of the rotor cover 360 with respect to the rotor core 30 can be achieved. Thus, it is made easier to arrange each of cover through holes 62a to overlap with a space circumferentially between adjacent ones of magnets 40 when viewed along the axial direction Z.

At least a portion of the second claw portion 364 is arranged in one of second core through holes 34b. This leads to a reduction in the likelihood that the second claw portion 364 will be pushed out of the second core through hole 34b by a resin when a resin portion 50 is made by the above-described insert molding process. In the present example embodiment, the second portion 364b of the second claw portion 364 is arranged in the core through hole 34. Circumferential end portions of the second portion 364b are arranged to be in contact with a wall surface of the core through hole 34, or circumferentially opposite thereto with a gap therebetween.

The present disclosure is not limited to the above-described example embodiments, and other configurations may alternatively be adopted. Each of the number of first joining portions and the number of second joining portions is not limited to particular values, and may be any desired value equal to or greater than one. In addition, each second joining portion may not necessarily pass through a space between circumferentially adjacent ones of the magnets as long as the second joining portion passes through one of the cover through holes. The number of magnets is not limited to particular values.

A portion of the resin portion may be arranged in the interior of each second core through hole. One of the opening portions of each second core through hole on both sides in the axial direction may be closed by the resin portion. The core through holes may include only the first core through holes, without including any second core through hole. The number of core through holes is not limited to particular values.

Although, in each of the above-described example embodiments, the rotor cover includes, as the claw portion(s), either the first claw portions or the second claw portion, this is not essential to the present disclosure. The rotor cover may alternatively include, as the claw portions, both the first claw portion(s) and the second claw portion(s). In the first example embodiment, the number of first claw portions 63 may alternatively be one or more than two. In the second example embodiment, the number of second claw portions 364 may alternatively be more than one. In this case, each of the second claw portions 364 is arranged in a separate one of the core through holes 34. The rotor cover may alternatively include no claw portion.

Each cover through hole may not necessarily be arranged to overlap with the space between circumferentially adjacent ones of the magnets when viewed along the axial direction Z. The flange portion may not necessarily be annular. The rotor cover may alternatively include, for example, a plurality of flange portions arranged apart from one another in the circumferential direction. The shaft may not necessarily be solid, but may alternatively be a hollow member. In each of the above-described example embodiments, the number of magnets 40 is eight (in other words, the number of poles is eight). Note, however, that the number of magnetic poles of the rotor may be appropriately changed. The shape of each magnet 40 is not limited to the above-described shape, but may alternatively be another shape. The rotor core body 31 may not necessarily be in the shape of a regular octagonal prism, but may alternatively be in any other desired shape, such as, for example, a polygonal prism or a columnar shape, in accordance with the number of magnets 40 and the shape of each magnet 40. The bearing holder 14 may alternatively be defined integrally with a cover member arranged to cover an opening of the housing 11. In other words, the bearing holder 14 and the cover member arranged to cover the opening of the housing 11 may be portions of a single monolithic member.

Motors including the rotor according to each of the above-described example embodiments may be used for any desired purpose. Motors including the rotor according to each of the above-described example embodiments are installed in, for example, an electric pump, an electric power steering system, and so on. Features described above may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-12. (canceled)

13: A rotor comprising:
a shaft extending along a central axis extending in an axial direction;
a rotor core fixed to the shaft;
at least one magnet radially outside of the rotor core;
a rotor cover including a tubular portion surrounding the rotor core and the at least one magnet on a radially outer side of the at least one magnet; and
a resin portion including at least a portion thereof radially inside of the rotor cover; wherein
the rotor core includes a core through hole passing through the rotor core in the axial direction;
the rotor cover includes a flange portion projecting radially inward from the tubular portion;
the flange portion is on a first side of the rotor core in the axial direction, and includes a cover through hole passing through the flange portion in the axial direction; and
the resin portion includes:
a first cover portion on the first side of the rotor core, the at least one magnet, and the flange portion in the axial direction;
a second cover portion on a second side of the rotor core and the at least one magnet in the axial direction;
a first joining portion extending in the axial direction through the core through hole to join the first cover portion and the second cover portion to each other; and
a second joining portion extending in the axial direction through the cover through hole to join the first cover portion and the second cover portion to each other.

14: The rotor according to claim 13, wherein
the at least one magnet includes a plurality of magnets spaced apart from one another in a circumferential direction; and
the second joining portion passes through a space between circumferentially adjacent ones of the magnets.

15: The rotor according to claim 14, wherein the cover through hole overlaps with the space between the circumferentially adjacent ones of the magnets when viewed along the axial direction.

16: The rotor according to claim 14, wherein
the flange portion includes a plurality of the cover through holes;
the resin portion includes a plurality of the second joining portions; and
each of the second joining portions passes through a separate one of the cover through holes.

17: The rotor according to claim 16, wherein
the flange portion is annular, and extends in the circumferential direction; and
the cover through holes are located along the circumferential direction all the way around the central axis.

18: The rotor according to claim 17, wherein
each cover through hole extends in the circumferential direction; and
the cover through hole has a circumferential dimension equal to or greater than a circumferential dimension of each magnet.

19: The rotor according to claim 16, wherein
a circumferential dimension of a portion of the flange portion between circumferentially adjacent ones of the cover through holes is smaller than a circumferential distance between the circumferentially adjacent ones of the magnets.

20: The rotor according to claim 13, wherein
the rotor core includes a plurality of the core through holes located along a circumferential direction all the way around the central axis;
at least one of the core through holes is a first core through hole including the first joining portion passing therethrough;
at least one of the other core through holes is a second core through hole at a position different from that of the first joining portion when viewed along the axial direction; and
at least one of opening portions of the second core through hole on both sides in the axial direction is exposed to an outside of the rotor.

21: The rotor according to claim 13, wherein
the rotor cover includes at least one claw portion projecting in the axial direction from the flange portion; and
the at least one claw portion is engaged with one of the rotor core and the resin portion.

22: The rotor according to claim 21, wherein
the rotor cover includes, as one of the at least one claw portion, a first claw portion projecting from the flange portion to the first side in the axial direction; and
the first claw portion is embedded in the first cover portion.

23: The rotor according to claim 22, wherein
the rotor cover includes, as one of the at least one claw portion, a second claw portion projecting from the flange portion to the second side in the axial direction; and
at least a portion of the second claw portion is in the core through hole.

24: A motor comprising:
the rotor of claim 13; and
a stator radially opposite to the rotor with a gap therebetween.
